(19) United States
(12) Patent Application Publication
(10) Pub. No.: US 2011/0162903 A1
(43) Pub. Date: Jul. 7, 2011

(54) BRAKE ENERGY RECOVERY SYSTEM

(76) Inventor: Marcel G. Stragier, Scottsdale, AZ (US)

(21) Appl. No.: 12/678,126

(22) PCT Filed: Nov. 22, 2005
(86) PCT No.: PCT/US05/42477

§ 371 Date: Mar. 24, 2011

(51) Int. Cl. B60T 1/12; F16D 61/00; B23P 11/00

(52) U.S. Cl. 180/165; 29/428

(57) ABSTRACT

A brake energy recovery system is used on a vehicle including an auxiliary hydraulic system. The recovery system includes a fluid accumulator and normally open and normally closed switches coupled to be closed and opened, respectively, when the brake pedal is depressed. A hydraulic charging valve is coupled to the outlet of a hydraulic pump and moveable from a neutral to a charging position when the normally open switch is closed. A motor valve is coupled to the inlet of the pump and moveable from a neutral to a driving position when the normally closed switch is in a closed position. The charging valve couples the outlet of the pump to the accumulator in the charging position and the motor valve couples the accumulator to the inlet of the pump in the driving position.

### TECHNICAL FIELD

This invention relates to an energy recovery system and more specifically to a system in which some energy expended in a vehicle during braking is recovered.

### BACKGROUND ART

It is well known that vehicles, such as trucks and the like, expend substantial energy when braking and accelerating. Generally, this energy is completely expended by the brakes or the engine. It is known that some of the braking energy, for example, can be bled off and stored. The stored energy can then be used in a later acceleration process. Generally, a major problem with systems that perform these functions is the complexity. In some instances the vehicles are substantially rebuilt or large quantities of expensive components must be added to fabricate the energy saving system.

An example of this type of system is disclosed in U.S. Pat. No. 4,760,697, entitled “Mechanical Power Regeneration System”. In systems such as this, a microcomputer is used to receive all sensor signals and to control all valves. Further, many sensors and valves must be integrated into the vehicle for operation with the normal operation of the vehicle. This integration of the many sensors, valves and other components into the vehicle is very expensive, labor intensive, and difficult. This results in a very complicated and expensive system that cannot easily be installed in any or all vehicles. That is, the vehicle itself must be a relatively expensive and complex vehicle, such as a bus or the like, to justify the installation of the very complicated and expensive system.

It would be highly advantageous, therefore, to remedy the foregoing and other deficiencies inherent in the prior art.

Accordingly, it is an object of the present invention to provide a new and improved brake energy recovery system and method of operation.

Another object of the invention is to provide a new and improved brake energy recovery system that is easier to manufacture and install.

And another object of the invention is to provide a new and improved brake energy recovery system that is less expensive to manufacture and operate.

Still another object of the present invention is to provide a new and improved brake energy recovery system that is simple enough to install on substantially any truck.

A further object of the present invention is to provide a new and improved brake energy recovery system that can simply be installed in trucks including hydraulic systems, such as refuse collection trucks by modifying or retrofitting the normal hydraulic system.

### DISCLOSURE OF THE INVENTION

Briefly, to achieve the desired objects of the instant invention in accordance with a preferred embodiment thereof, provided is a brake energy recovery system for use on a vehicle including an engine, an auxiliary hydraulic system with a hydraulic pump having a fluid inlet and a fluid outlet and a reservoir, a brake pedal, an operating system (e.g. electrical, air, hydraulic, etc.), and the fluid inlet of the hydraulic pump coupled in fluid communication to the reservoir. The brake energy recovery system includes a high pressure hydraulic fluid accumulator. The recovery system also includes a normally open switch mechanically couplable to the brake pedal so as to be closed when the brake pedal is depressed and a normally closed switch mechanically couplable to the brake pedal so as to be opened when the brake pedal is depressed. It will of course be understood that the normally open and normally closed switches could be electrically coupled to the brake light or could actually incorporate the brake light as one or both of the switches. Also, in conjunction with a pneumatic (air) or hydraulic operating system the switches could be air or hydraulic valves or the like. The normally open switch and the normally closed switch are coupled to the operating system. A hydraulic charging valve is couplable to the fluid outlet of the hydraulic pump moveable between a charging position and a neutral position. The charging valve includes an actuator coupled to the normally open switch for moving the charging valve from the neutral position to the charging position in response to an operating communication (an electrical signal, an applied voltage, a change in air pressure or hydraulic pressure, etc.) received from the operating system. The operating communication is received when the normally open switch is in a closed position. A hydraulic motor valve is couplable to the fluid inlet of the hydraulic pump and moveable between a driving position and a neutral position. The motor valve includes an actuator coupled to the normally closed switch for moving the motor valve from the neutral position to the driving position in response to an operating communication received from the operating system. The operating communication is removed when the normally closed switch is in an open position. The charging valve couples in fluid communication the fluid outlet of the pump to the accumulator when the charging valve is in the charging position and the motor valve couples in fluid communication the accumulator to the fluid inlet of the pump when the motor valve is in the driving position.

In one embodiment, criteria sensors and/or switches are connected in series with one or both of the normally open and normally closed switches operated by the brake pedal and the actuators of one or both of the charging valve and the motor valve. The criteria sensors and/or switches are designed to complete or open an electrical, air, or hydraulic circuit in response to a selected criteria, the pressure in the accumulator, the speed of the vehicle, etc. Preferably, the criteria switches are used to ensure that the brake energy recovery system only operates when the vehicle is moving and that the stored pressure is between Certain useable and safe limits.

The desired objects of the instant invention are further achieved in accordance with a preferred embodiment thereof in a method of installing a brake energy recovery system in a vehicle. The method includes a step of providing a vehicle including an engine, an auxiliary hydraulic system with a reservoir and a hydraulic pump, a brake pedal, an operating system, the hydraulic pump being mechanically coupled to the engine for rotation therewith and having a fluid inlet and a fluid outlet, and the reservoir coupled in fluid communication to the fluid inlet of the pump. The following steps of the method are performed in any convenient order. A normally open switch is coupled to the brake pedal so as to be closed when the brake pedal is depressed and a normally closed switch is coupled to the brake pedal so as to be opened when the brake pedal is depressed. It will be understood that these switches may be or may incorporate the brake light switch that is normally included in a vehicle. An actuator of a hydraulic charging valve moveable between a charging position and a neutral position is coupled to the operating system through the normally open switch, for moving the hydraulic charging valve from the neutral position to the charging position in response to an operating communication received from the operating system. The fluid outlet of the hydraulic pump is hydraulically coupled through the hydraulic charging valve in the neutral position to the auxiliary hydraulic system. The fluid outlet of the hydraulic pump is hydraulically coupled through the hydraulic charging valve in the charging position to a high pressure hydraulic fluid accumulator. An actuator of a hydraulic motor valve moveable between a driving position and a neutral position is coupled to the operating system through the normally closed switch, for moving the hydraulic motor valve from the neutral position to the driving position in response to an operating communication received from the operating system. The fluid inlet of the hydraulic pump is hydraulically coupled through the hydraulic motor valve in the neutral position to the auxiliary hydraulic system. The high pressure hydraulic fluid accumulator is hydraulically coupled through the hydraulic motor valve in the motor position to the fluid inlet of the hydraulic pump. When the brake pedal is depressed fluid is pumped from the hydraulic pump into the accumulator until either the vehicle stops or the pressure reaches a preset maximum and when the brake pedal is released the high pressure fluid stored in the accumulator is applied to the hydraulic pump to drive the pump and the connected vehicle engine until the accumulator exhausts or reaches a preset minimum pressure. Thus, any new or currently existing vehicle can be altered to include the new and improved brake energy recovery system.

### BRIEF DESCRIPTION OF THE DRAWINGS

The foregoing and further and more specific objects and advantages of the instant invention will become readily apparent to those skilled in the art from the following detailed description of a preferred embodiment thereof taken in conjunction with the drawings, in which:

FIG. 1 is a side view of a typical vehicle engine with a brake energy recovery system incorporating an embodiment of the present invention;

FIG. 2 is a schematic representation of the hydraulic system of the brake energy recovery system of FIG. 1;

FIG. 3 is a schematic representation of one embodiment of an electric system for the brake energy recovery system of FIG. 2;

FIG. 4 is a schematic representation of another embodiment of an electric system for the brake energy recovery system of FIG. 2;

FIG. 5 is a schematic representation of another embodiment of a brake energy recovery system used in conjunction with a refuse collection hydraulic system in accordance with the present invention;

FIG. 6 is a schematic representation of additional apparatus for use with the brake energy recovery system of FIG. 5; and

FIG. 7 is a schematic representation of another embodiment of a brake energy recovery system used in conjunction with a refuse collection hydraulic system in accordance with the present invention.

### BEST MODES FOR CARRYING OUT THE INVENTION

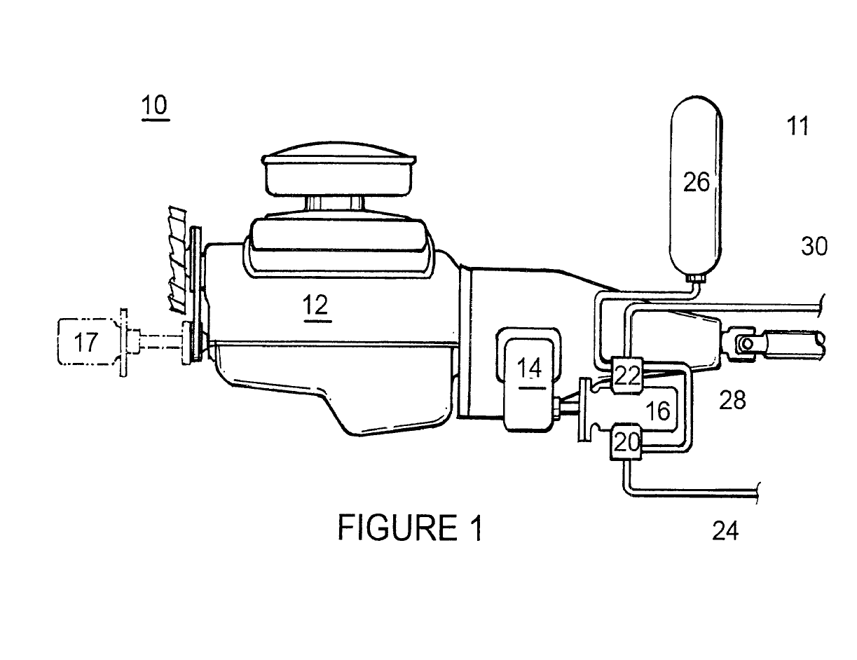

Turning now to the drawings, attention is first directed to FIG. 1, which illustrates a vehicle 10 including an engine 12 and incorporating a brake engine recovery system, generally designated 11, in accordance with the present invention. It should be understood that brake engine recovery system 11 can be initially built into vehicle 10 or vehicle 10 can be an existing vehicle that is retrofit with system 11, in either case vehicle 10 can be considered a part of brake recovery system 11 or vise versa. Many vehicles, such as refuse collection vehicles or dump trucks, are equipped with auxiliary hydraulic systems which can be easily modified to provide a limited energy recovery. In this embodiment, engine 12 has a standard power takeoff 14 associated therewith to drive a hydraulic pump 16, which may be added for purposes of this invention or may be part of a hydraulic system already built into vehicle 10 (e.g. vehicle 10 could be a refuse collection truck or the like). As the disclosure proceeds, it will be clear to those skilled in the art that hydraulic pump 16 could be driven directly from engine 12, as indicated, for example, by broken lines at 17. However, power takeoff 14 is preferred because the entire hydraulic system can easily be switched into or out of operation when power takeoff 14 is used.

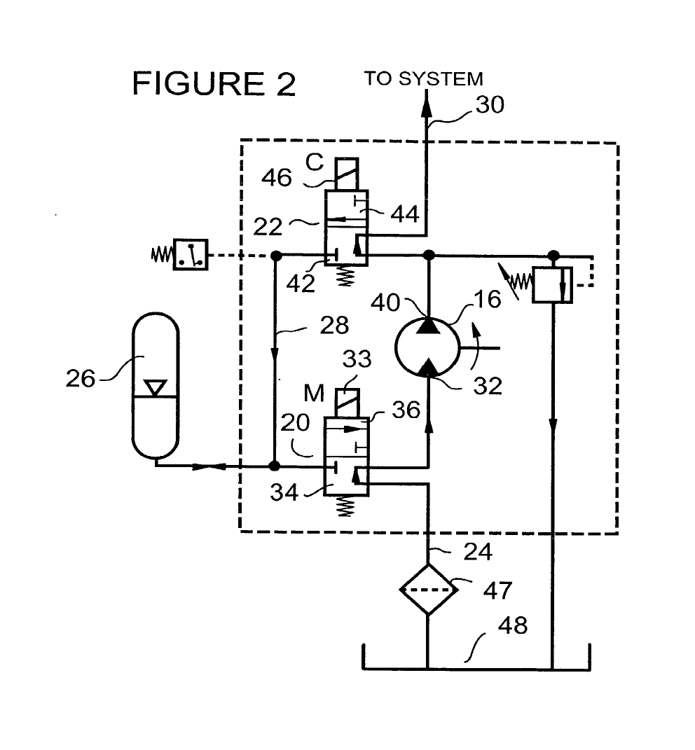

Referring additionally to FIG. 2, a schematic representation of brake engine recovery system 11 of FIG. 1 is illustrated. A hydraulic motor valve 20 is connected to a fluid inlet 32 of hydraulic pump 16 and is moveable between a neutral position 34 and a driving position 36 by an electric actuator 38. A hydraulic charging valve 22 is connected to a fluid outlet 40 of hydraulic pump 16 and is moveable between a neutral position 42 and a charging position 44 by an electric actuator 46. Here it will be understood that motor valve 20 and charging valve 22 can be, for example, simple slide actuated valves that are spring biased into the neutral position and are moved to the driving position and charging position, respectively, by a type of solenoid action provided by applying a voltage to actuators 38 and 46.

Motor valve 20, when in neutral position 34, connects or hydraulically couples fluid inlet 32 of hydraulic pump 16 through a filter 47 to a reservoir 48, represented in FIG. 1 by a hydraulic line 24, generally included in a complete hydraulic system of the vehicle 10, as will be explained presently. Charging valve 22, when in neutral position 42, connects or hydraulically couples fluid outlet 40 of hydraulic pump 16 to a fluid inlet of the system, represented by a hydraulic line 30. Thus, in this normal operating mode hydraulic fluid is pumped from reservoir 48 of the hydraulic system to fluid inlet 30 of the hydraulic system in a normal operating manner.

In a charging or energy storage mode of operation, an actuating voltage is applied to actuator 46 of charging valve 22 and charging valve 22 is moved into charging position 44, which hydraulically connects fluid outlet 40 of hydraulic pump 16 to a high pressure hydraulic fluid accumulator 26 and removes the connection to fluid inlet 30 of the hydraulic system. Further, in this charging or energy storage mode, motor valve 20 remains in neutral position 34, so that hydraulic fluid is pumped from reservoir 48 of the hydraulic system to high pressure hydraulic fluid accumulator 26. In a preferred embodiment, the charging or energy storage mode is initiated by applying pressure or depressing the brake pedal of the vehicle and may, in some applications include other criteria, e.g. speed, pressure in fluid accumulator 26, etc. as will be explained in more detail presently. Here it should be noted that in the charging or energy storage mode not only is energy stored in the form of high pressure hydraulic fluid but the operation of hydraulic pump 16 to pump fluid into fluid accumulator 26 will provide a drag on engine 12 to help slow it down and reduce the braking required.

In a driving or stored-energy-use mode of operation, charging valve 22 remains in neutral position 42 and an actuating voltage is applied to actuator 38 of motor valve 20, moving it to driving position 36. In this driving mode, high pressure hydraulic fluid accumulator 26 is connected through motor valve 20 to fluid inlet 32 of hydraulic pump 16 and fluid outlet 40 of pump 16 is connected to hydraulic line 30 by charging valve 22. Thus, high pressure hydraulic fluid (energy) stored or accumulated in accumulator 26 is used to drive pump 16 and aid vehicle 10 during acceleration. In a preferred embodiment, the driving or stored-energy-use mode is initiated by releasing the brake pedal of the vehicle and may, in some applications include other criteria, e.g. speed, pressure in fluid accumulator 26, etc. as will be explained in more detail presently.

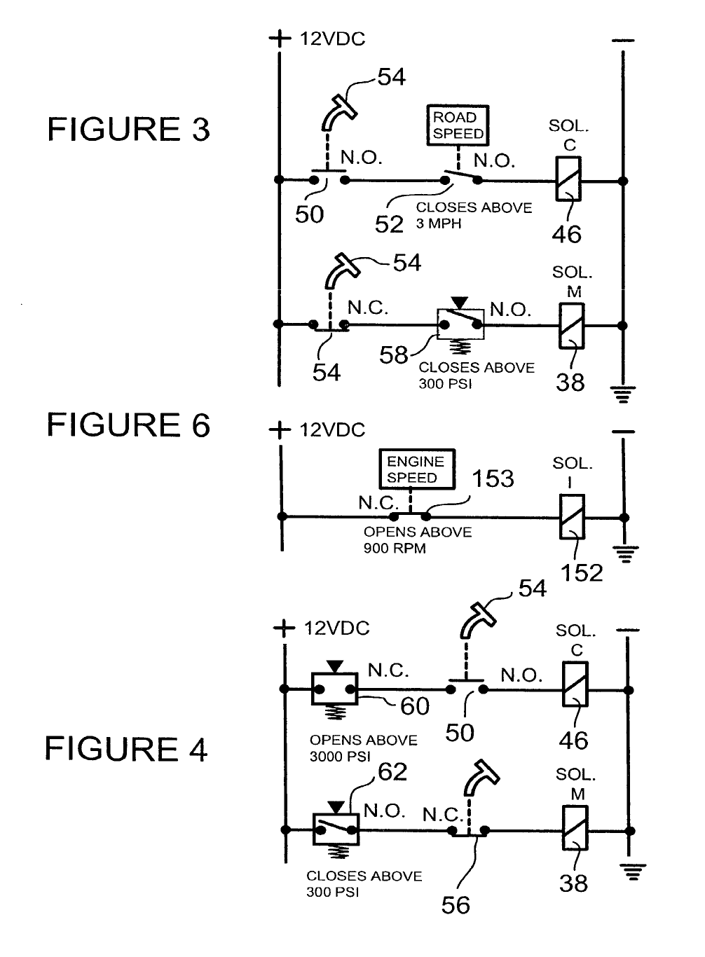

Referring additionally to FIG. 3, a simplified schematic diagram is illustrated of an electrical system for one embodiment of brake engine recovery system 11. For convenience positive power for system 11 is provided by the battery of vehicle 10, indicated as 12 VDC, and the negative pole is simply ground or the chassis of vehicle 10. A normally open switch 50 is connected in series with a normally open criteria switch 52 and actuator 46 of charging valve 22 between the 12 volts DC and ground. Thus, in this embodiment both switches 50 and 52 must be closed to apply an activating voltage to actuator 46 and begin the charging or energy storage mode.

In this embodiment, normally open switch 50 is closed by depressing the brake pedal (represented by pedal 54). In its simplest form, switch 50 could be the normally open switch associated with the brake pedal of a vehicle that supplies power to the brake lights when the pedal is depressed. Also, in this embodiment, normally open criteria switch 52 includes a sensor that detects road speed and switch 52 could be any switch that closes automatically when vehicle 10 reaches a preset speed, e.g. 3 miles per hour. As an example, a simple centrifugal switch can be employed for normally open criteria switch 52. It will be understood that a road speed criteria is used in this embodiment because applying an actuating voltage to actuator 46 when vehicle 10 is stopped or substantially stopped would result in a waste of energy, rather than a recovery of energy.

In this embodiment, a normally closed switch 56 is connected in series with an optional normally open criteria switch 58 and actuator 38 of motor valve 20 between the 12 volts DC and ground. Normally closed switch 56 is opened when brake pedal 54 is depressed and is closed again by removing pressure from or releasing brake pedal 54. In its simplest form, switch 56 could be a second pole of switch 50 (i.e. single throw, double pole switch), e.g. the normally open switch associated with the brake pedal of a vehicle that supplies power to the brake lights when the pedal is depressed. The criteria that operates switch 58 in this embodiment is a pressure sensor or switch on high pressure hydraulic fluid accumulator 26 that can be set or selected to close at any desired pressure, e.g. 300 PSI. Thus, in this embodiment brake pedal 54 must be released to allow switch 56 to close and criteria switch 58 must be closed to apply an activating voltage to actuator 38 and initiate the driving or stored-energy-use mode of operation. Criteria switch ensures that there is sufficient hydraulic pressure (stored energy) in fluid accumulator 26 to drive pump 16 in a useful manner.

Turning now to FIG. 4, a simplified schematic diagram is illustrated of an electrical system for another embodiment of brake engine recovery system 11. In this embodiment a normally open switch 50, associated with brake pedal 54, is connected in series with a normally closed criteria switch 60 and actuator 46 of charging valve 22 between the 12 volts DC and ground. In this embodiment, since switch 60 is normally closed, switch 50 must be closed (brake pedal 54 depressed) to apply an activating voltage to actuator 46 and begin the charging or energy storage mode. In a preferred embodiment, switch 60 is a pressure sensor associated with fluid accumulator 26 that opens above a selected high pressure (e.g. 3000 PSI) to provide safety against introducing excessively high pressures in fluid accumulator 26. Thus, criteria switch 60 allows the charging or energy storage mode to continue until an upper safe pressure is achieved in fluid accumulator 26, at which time energy storage is automatically discontinued.

Also, in the embodiment of FIG. 4, a normally closed switch 56, associated with brake pedal 54, is connected in series with an optional normally open criteria switch 62 and actuator 38 of motor valve 20 between the 12 volts DC and ground. Both switches 62 and 56 must be closed to provide an activating voltage to actuator 38 and initiate the driving or stored-energy-use mode of operation. Since criteria switch 62 remains open until a sufficient or minimal amount of pressure or hydraulic fluid has been stored, (e.g. 300 PSI), the driving or stored-energy-use mode of operation cannot be initiated until a minimum hydraulic pressure is stored. Thus, in this embodiment normally open criteria switch 62 prevents the driving or stored-energy-use mode of operation when brake pedal 54 is released to close switch 56, if sufficient pressure has not been stored in fluid accumulator 26.

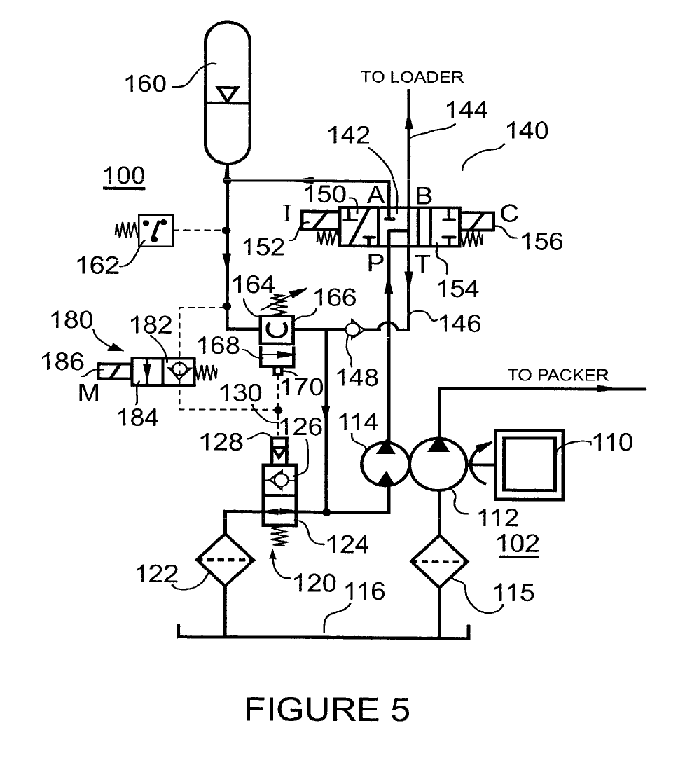

It will be understood that second criteria switch 58 in FIG. 3 and second criteria switch 62 in FIG. 4 could be removed and motor valve 20 with actuator 38 could be replaced with a fluid operated check valve, generally as described in conjunction with the brake recovery system of FIG. 5. It will of course be understood that the normally open and normally closed switches are used in the specific embodiment for purposes of example and could be any type of switch that performs the function of transmitting some type of impulse when operated by operation (depressing and/or releasing) of the brake pedal. For example, in an electrical operating system the switch or switches could be electrically coupled to the brake light or could actually incorporate the brake light as one or both of the switches. Also, in conjunction with a pneumatic (air) or hydraulic operating system the switches could be air valves or hydraulic valves or the like, in which case the transmitted impulse would be an impulse of air or a hydraulic fluid impulse rather than an electrical impulse.

Referring to FIG. 5, another embodiment is illustrated of a brake recovery system 100 used in conjunction with a refuse collection hydraulic system 102 in accordance with the present invention. In this specific application of brake recovery system 100, the refuse collection vehicle is a standard manufacture and includes at least a refuse loader and a refuse packer, the operation of which is well known in the art and will not be described in detail. An engine or motor 110 of the refuse collection vehicle drives a first hydraulic pump 112 and a second hydraulic pump 114, either directly or through a power takeoff, as explained above. While a two pump system is not required and may not be used in originally fabricated systems, the high pressure hydraulic fluid stored as energy in recovery system 100 may be too high for the relatively large openings in pump 112 and, thus, preferably a pump with smaller openings is provided when a retrofit is performed in either a new or existing vehicle.

A fluid inlet of hydraulic pump 112 is connected through a filter 115 to a reservoir 116 and a fluid outlet of pump 112 supplies hydraulic fluid under pressure to the packer of the refuse collection vehicle. The construction and operation of this portion of hydraulic system 102 is well known and will not be described further. Also, while fluid returns for the reservoirs described in hydraulic system 102 are not described in detail, the operation and construction of such returns are well known in the art and will not be described in detail to simplify the disclosure.

A fluid inlet of hydraulic pump 114 is connected through a two-position hydraulic valve 120 and a filter 122 to hydraulic reservoir 116. Two-position valve 120 has a neutral position 124 (shown in FIG. 5) in which fluid flows straight through from reservoir 116 to pump 114, and a blocking position 126 in which a check valve is incorporated to prevent fluid flow into reservoir 116. Two-position valve 120 is normally in the neutral position and may be biased into this position, for example by a spring or the like. A hydraulically operated actuator 128 moves two-position valve 120 from neutral position 124 to blocking position 126 when a sufficient hydraulic pressure is applied thereto from an actuator line 130, illustrated in broken lines.

A fluid outlet of hydraulic pump 114 is connected through a three-position hydraulic valve 140 to any one of three different hydraulic paths. Three-position hydraulic valve 140 includes a neutral position 142, which it is biased into from either of the other positions by springs or the like. In the neutral position fluid is directed from the fluid outlet of pump 114 to the loader by way of a hydraulic line 144. A second hydraulic line 146 includes a check valve 148 to limit the direction of fluid flow therein and may be included, for example, as a fluid return or relief path when none of the hydraulic components (e.g. loader, etc.) are being used. Generally, the neutral position is supplied for use when engine 110 of the refuse collection vehicle is operating above an idling speed. In normal operation, in this example configuration, pump 114 has a relatively large capacity able to operate the loader at idle so that the system can be operated without shifting to neutral.

Three-position hydraulic valve 140 includes an idle position 150 controlled by an electrical actuator 152. Generally, anytime engine or motor 110 of the refuse collection vehicle is idling (i.e. low engine speed), an actuating voltage is applied to electrical actuator 152 to move three-position hydraulic valve 140 into idle position 150 (to the right in FIG. 5). Electrical actuator 152 may be connected, for example, through a speed sensor switch 153 (see FIG. 6 for an electrical representation) that closes and applies an actuating voltage whenever the speed is below a predetermined value (e.g. 900 RPM). In this position hydraulic fluid from pump 114 is directed into the loader by way of hydraulic line 144.

Three-position hydraulic valve 140 includes a charging position 154 controlled by an electrical actuator 156. As described in detail above, an actuating voltage may be applied to actuator 156 whenever, for example, the brake pedal is depressed and the speed of engine or motor 110 is sufficiently high so that actuator 152 is not activated. In this position hydraulic fluid from pump 114 is directed into a high pressure hydraulic accumulator 160 and stored for later energy recovery. As explained above, the circuit applying an actuating voltage to actuator 156 may include one or more criteria switches, such as a maximum safe pressure (e.g. 3000 PSI) that can be stored. Such a pressure sensor and switch combination might be, for example, coupled to the output fluid line of accumulator 160 at 162 for convenience and connected electrically into the system generally as shown in FIG. 4.

The output fluid line of accumulator 160 is connected in fluid communication with a two-position valve 164, the fluid outlet of which is connected to the fluid inlet of pump 114. Two-position valve 164 is similar to two-position valve 120, except that it normally resides in a blocking position 166, in which fluid is blocked by a check valve from flowing out of accumulator 160, and also includes a flow through position 168, in which fluid is free to flow from accumulator 160 to the fluid inlet of pump 114. Two-position valve 164 is normally biased into blocking position 166 by a spring or the like and a hydraulically operated actuator 170 moves two-position valve 164 from blocking position 166 to the flow through position 168 when a sufficient hydraulic pressure is applied thereto from actuator line 130.

Thus, two-position valves 120 and 164 are both actuated by hydraulic pressure on actuator line 130 and operate in opposition so that with no pressure fluid is free to flow from reservoir 116 to pump 114 but fluid flow from accumulator 160 to pump 114 is blocked. When pressure is applied to actuator line 130, fluid flow from reservoir 122 to pump 114 is blocked by two-position valve 120 and high pressure is free to flow through two-position valve 164 from accumulator 160 to pump 114.

A two-position motor valve 180 is provided to couple hydraulic pressure to actuator line 130 from the fluid outlet of accumulator 160. Motor valve 180 has a blocking position 182 (shown in FIG. 5) in which no actuator fluid flows and a flow through position 184 in which actuator fluid flows from accumulator 160. To prevent undue build-up of actuator pressure, blocking position 182 incorporates a check valve that allows fluid flow from actuator line 130 into the line from accumulator 160. Motor valve 180 is normally in blocking position 182 and may be biased into this position, for example by a spring or the like. An electrically operated actuator 186 moves motor valve 180 from blocking position 182 to flow through position 184 when an activating voltage is applied to actuator 186. In this embodiment, the activating voltage is applied when the brake pedal of the collection vehicle is depressed. Simultaneously, when the brake pedal is depressed and the speed of engine 110 is sufficiently high so that actuator 152 is not activated, an actuating voltage is applied to actuator 156, which hydraulically couples the fluid outlet of pump 114 to accumulator 160. One or more other criteria may be incorporated into the system, as described above in conjunction with the description of previous embodiments, if desired.

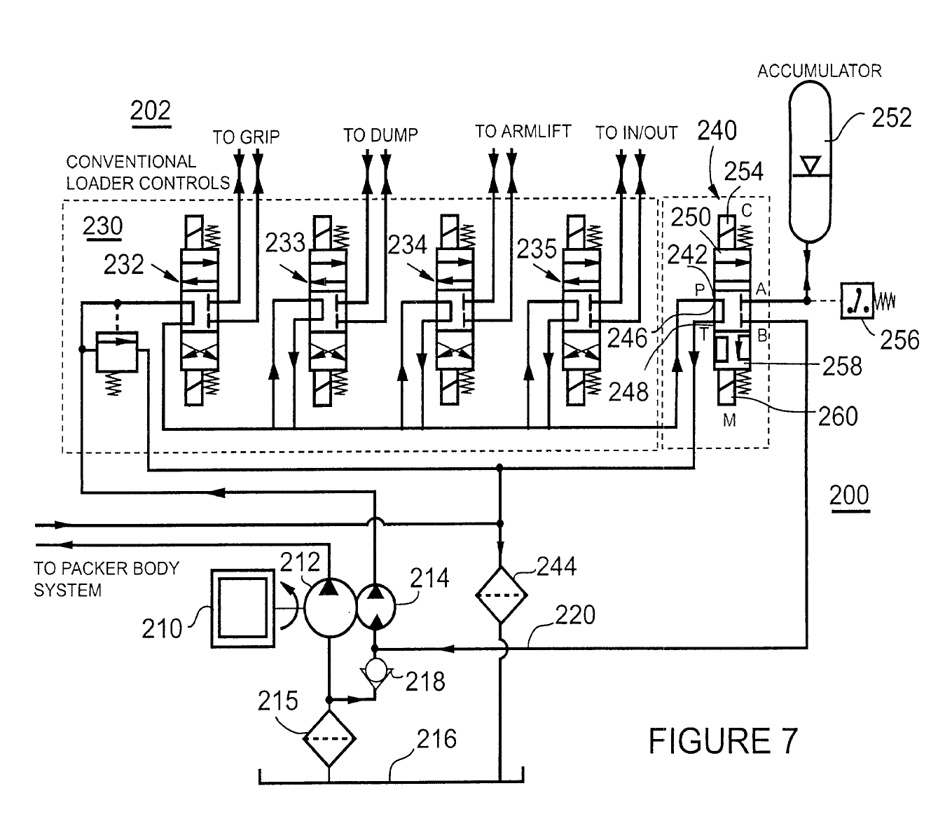

Referring to FIG. 7, an embodiment of a brake energy recovery system 200 is illustrated incorporating, or retrofitting, brake energy recovery system 200 into an existing hydraulic system 202 on a vehicle, such as a refuse collection vehicle. In this specific application of brake recovery system 200, the refuse collection vehicle is a standard manufacture and includes several hydraulically operated components and a refuse packer, the operation of which is well known in the art and will not be described in detail. An engine or motor 210 of the refuse collection vehicle drives a first hydraulic pump 212 and a second hydraulic pump 214, either directly or through a power takeoff, as explained above. While a two pump system is not required and may not be used in originally fabricated systems, the high pressure hydraulic fluid stored as energy in recovery system 200 may be too high for the relatively large openings in pump 212 and, thus, preferably pump 214 with smaller openings is provided in this retrofit of existing vehicles.

A fluid inlet of hydraulic pump 212 is connected through a filter 215 to a reservoir 216 and a fluid outlet of pump 212 supplies hydraulic fluid under pressure to the packer (not shown) of the refuse collection vehicle. The construction and operation of this portion of hydraulic system 202 is well known and will not be described further. Also, while fluid returns for the reservoirs described in hydraulic system 202 are not described in detail, the operation and construction of such returns are well known in the art and will not be described in detail to simplify the disclosure.

A fluid inlet of hydraulic pump 214 is coupled to filter 215 and reservoir 216 through a check valve 218 that allows normal fluid flow out of reservoir 216 but does not allow high pressure hydraulic fluid to flow into reservoir 216. A hydraulic line 220 is connected to the fluid inlet of hydraulic pump 214, between the fluid inlet and check valve 218, to return high pressure hydraulic fluid to drive pump 214 as will be explained presently.

Loader controls 230 provided on the collection truck include a plurality of three-position hydraulic valves, in this example four valves, designated 232, 233, 234, and 235, that are used to perform a plurality of well known functions. For example, valve 232 controls (closes and opens) a grip at the end of an arm used to pick up or grip refuse containers, valve 233 causes the arm to be moved so as to dump the gripped refuse container, valve 234 controls movement of the arm in a vertical or lifting direction, and valve 235 controls movement of the arm in a horizontal or in/out direction. Each three-position hydraulic valve 232-235 includes a neutral position (all valves are illustrated in the neutral position), which it is biased into from either of the other positions by springs or the like. In the neutral position fluid is directed from a fluid inlet into a fluid outlet without flowing to the component being controlled. Each three-position hydraulic valve 232-235 also includes a forward movement position and a reverse movement position, all of which operate in a well known manner and will not be explained further.

In this embodiment, a fifth three-position hydraulic valve, generally designated 240, is provided as a component of brake recovery system 200. Hydraulic valve 240 also includes a neutral position 242 (the position illustrated in FIG. 7) and is hydraulically coupled in series with hydraulic valves 232-235. To explain the series connection, the fluid input of valve 232 is connected to the fluid output of pump 214, the fluid return of valve 232 is connected to the fluid input of valve 233, the fluid return of valve 233 is connected to the fluid input of valve 234, the fluid return of valve 234 is connected to the fluid input of valve 235, the fluid return of valve 235 is connected to a fluid input (designated 246) of valve 240, and a fluid return of valve 240 (designated 248) is connected through a return filter 244 to reservoir 216. While the series connection of the various three-position hydraulic valves is preferred for simplicity, it will be understood that any other connections and styles of valves can be used to achieve the desired results.

Three-position hydraulic valve 240 also includes a charging position 250 in which fluid input 246 is connected to a fluid inlet/outlet of a high pressure hydraulic accumulator 252 and fluid return 248 is connected to hydraulic line 220. Hydraulic valve 240 is moved into charging position 250 when an actuating voltage is provided to an actuator 254, for example by depressing the brake pedal of the collection vehicle as described in the above embodiments. In charging position 250, hydraulic fluid is stored in accumulator 252 as stored energy. A pressure sensor and switch combination might be, for example, coupled to the input/output of accumulator 252 at 256 for convenience and connected electrically into the system generally as shown in FIG. 4.

Three-position hydraulic valve 240 also includes a motor position 258 in which fluid input 246 is connected to fluid return 248. Also, fluid inlet/outlet of high pressure hydraulic accumulator 252 is connected to hydraulic line 220 to supply high pressure hydraulic fluid from accumulator 252 to the fluid input of pump 214. Hydraulic valve 240 is moved into motor position 258 when an actuating voltage is provided to an actuator 260, for example by releasing the depressed brake pedal of the collection vehicle as described in the above embodiments. Various criteria switches might be connected into the electrical circuit applying an actuating voltage to either or both actuators 254 and 260, if desired, generally as shown in FIG. 3 or 4.

Thus, a new and improved brake energy recovery system and method of operation is disclosed. The new and improved brake energy recovery system is easier to manufacture and install than any known prior art systems and it can be retrofit into existing vehicles without substantial modifications of the vehicles. Because of the simplicity and ease with which existing vehicles can be retrofit, the new and improved brake energy recovery system is less expensive to manufacture and operate. As can be seen from the above description, the new and improved brake energy recovery system is simple to install on substantially any truck and especially trucks including hydraulic systems, such as refuse collection trucks. Further, while the systems disclosed are coupled to the electrical system for actuation and may operate, for example from the brake light, it will be understood that the system could be coupled to an air brake and the various valves operated or actuated by air pressure from the brake system. Thus, the operating system could be an electrical system, an air system, or a hydraulic system, depending upon convenience and the specific application and the normally open and normally closed switches could be electrical switches, air valves, hydraulic valves, etc. Also, it will be understood that in specific applications the normally open switch and normally closed switch can be the same switch operating in two different modes. In other words, a single switch can be used to operate an actuator. Here it will be understood that the operating system sends an operating communication (e.g. an electrical signal, an operating voltage, a change of air pressure or hydraulic fluid pressure, etc.) directly to the various valves in response to operation of the brake pedal (either depressing or releasing). Further, while the various valves are illustrated and described as driven in one direction and spring biased into an opposite direction, it will be understood that they could be opposite the embodiments disclosed, or any combination of the two, if desired.

Various changes and modifications to the embodiments herein chosen for purposes of illustration will readily occur to those skilled in the art. To the extent that such modifications and variations do not depart from the spirit of the invention, they are intended to be included within the scope thereof which is assessed only by a fair interpretation of the following claims.

Having fully described the invention in such clear and concise terms as to enable those skilled in the art to understand and practice the same, the invention claimed is:

1. A brake energy recovery system for use on a vehicle including an engine, an auxiliary hydraulic system with a hydraulic pump having a fluid inlet and a fluid outlet and a reservoir, a brake pedal, an operating system, and the fluid inlet of the hydraulic pump coupled in fluid communication to the reservoir, the brake energy recovery system comprising:
a high pressure hydraulic fluid accumulator;
a switch couplable to the brake pedal so as to transmit first depressed and a second impulse when the brake pedal is released, the switch being coupled to the operating system;
a hydraulic charging valve couplable to the fluid outlet of the hydraulic pump and moveable between a charging position and a neutral position, the charging valve including an actuator coupled to the switch to receive the first impulse for moving the charging valve from the neutral position to the charging position in response to an operating communication received from the operating system, the operating communication is received when the brake pedal is depressed;
a hydraulic motor valve couplable to the fluid inlet of the hydraulic pump and moveable between a driving position and a neutral position, the motor valve including an actuator coupled to the switch to receive the second impulse for moving the motor valve from the neutral position to the driving position in response to an operating communication received from the operating system, the operating communication is received when the brake pedal is released;
the charging valve coupling in fluid communication the fluid outlet of the pump to the accumulator when the charging valve is in the charging position; and
the motor valve coupling in fluid communication the accumulator to the fluid inlet of the pump when the motor valve is in the driving position.

2. A brake energy recovery system as claimed in claim 1 wherein the operating system is one of an electrical system, an air system, and a hydraulic system and the switch transmitting the first and second impulses is one of an electrical switch, an air valve, and a hydraulic valve.

3. A brake energy recovery system as claimed in claim 1 wherein at least the first impulse is transmitted by a brake light switch of the vehicle.

4. A brake energy recovery system as claimed in claim 1 further including a criteria switch connected in series with the switch and the actuator of the hydraulic charging valve for communicating the first impulse.

5. A brake energy recovery system as claimed in claim 4 wherein the criteria switch includes a normally closed criteria switch connected to open when the vehicle reaches a predetermined speed.

6. A brake energy recovery system as claimed in claim 5 wherein the normally closed criteria switch is connected to open when the vehicle reaches a speed of 3 miles per hour or less.

7. A brake energy recovery system as claimed in claim 4 wherein the criteria switch includes a normally closed criteria switch connected to open when pressure within high pressure hydraulic fluid accumulator reaches a predetermined value.

8. A brake energy recovery system as claimed in claim 7 wherein the normally closed criteria switch is connected to open when the pressure within high pressure hydraulic fluid accumulator reaches a value of at least 3000 PSI.

9. A brake energy recovery system as claimed in claim 1 further including a criteria switch connected in series with the switch and the actuator of the hydraulic motor valve for communicating the second impulse.

10. A recovery system as claimed in claim 9 wherein the criteria switch includes a normally open criteria switch connected to close when pressure within high pressure hydraulic fluid accumulator reaches a predetermined value.

11. A brake energy recovery system as claimed in claim 10 wherein the normally open criteria switch is connected to close when the pressure within high pressure hydraulic fluid accumulator reaches a value of at least 300 PSI.

12. A brake energy recovery system as claimed in claim 1 further including a hydraulic idling valve couplable to the fluid outlet of the hydraulic pump and moveable between an idling position and a neutral position, the idling valve including an actuator coupled to a normally closed criteria switch and couplable to the operating system for moving the idling valve from the neutral position to the idling position in response to an operating communication received from the operating system, the operating communication is applied when the normally closed switch is in a closed position, the idling valve coupling in fluid communication the fluid outlet of the pump to the hydraulic system when the idling valve is in the idling position.

13. A brake energy recovery system as claimed in claim 12 wherein the normally closed criteria switch includes an engine speed sensor and switch designed to open when the speed of the engine is at least 900 RPM.

14. A brake energy recovery system for use on a vehicle including an auxiliary hydraulic system with a hydraulic pump having a fluid inlet and a fluid outlet and a reservoir, a brake pedal, an operating system, and the fluid inlet of the pump coupled in fluid communication to the reservoir, the brake energy recovery system comprising:
a high pressure hydraulic fluid accumulator;
a brake switch couplable to the brake pedal so as to provide a first signal when the brake pedal is depressed and a second signal when the brake pedal is released;
a first criteria sensor including a first criteria switch coupled in series to the brake switch and the operating system and operable to transmit the first signal in response to a first criteria;
a hydraulic charging valve couplable to the fluid outlet of the hydraulic pump and moveable between a charging position and a neutral position, the charging valve including an actuator coupled to the brake switch and the first criteria switch for moving the charging valve from the neutral position to the charging position in response to an actuating signal received from the operating system, the actuating signal is received only when transmitted in series from the brake switch through the first criteria switch;
a motor valve couplable to the fluid inlet of the hydraulic pump and moveable between a driving position and a neutral position, the motor valve including an actuator coupled to receive the second signal for moving the motor valve from the neutral position to the driving position in response to an actuating signal received only when the brake is released;
the charging valve coupling in fluid communication the fluid outlet of the pump to the accumulator when the charging valve is in the charging position; and
the motor valve coupling in fluid communication the accumulator to the fluid inlet of the pump when the motor valve is in the driving position.

15. A brake energy recovery system as claimed in claim 14 wherein at least a portion of the brake switch providing the first signal is a brake light switch of the vehicle.

16. A brake energy recovery system as claimed in claim 14 wherein the first criteria switch includes a normally open criteria switch connected to close when the vehicle reaches a predetermined speed.

17. A brake energy recovery system as claimed in claim 16 wherein the normally open first criteria switch is connected to close when the vehicle reaches a speed of at least 3 miles per hour.

18. A brake energy recovery system as claimed in claim 14 wherein the first criteria switch includes a normally closed first criteria switch connected to open when pressure within high pressure hydraulic fluid accumulator reaches a predetermined value.

19. A brake energy recovery system as claimed in claim 18 wherein the normally closed first criteria switch is connected to open when the pressure within high pressure hydraulic fluid accumulator reaches a value of at least 3000 PSI.

20. A brake energy recovery system as claimed in claim 14 further including a second criteria sensor including a second criteria switch operable to transmit the second signal in response to a second criteria, the second criteria switch coupled in series with the brake switch, the series coupled second criteria switch and brake switch couplable to the operating system.

21. A brake energy recovery system in claim 20 wherein the second criteria switch is connected to operate when pressure within high pressure hydraulic fluid accumulator reaches a predetermined value.

22. A brake energy recovery system as claimed in claim 21 wherein the second criteria switch is connected to operate when the pressure within high pressure hydraulic fluid accumulator reaches a value of at least 300 PSI.

23. A brake energy recovery system as claimed in claim 14 further including a hydraulic idling valve couplable to the fluid outlet of the hydraulic pump and moveable between an idling position and a neutral position, the idling valve including an actuator coupled to a third criteria switch and couplable to the operating system for moving the idling valve from the neutral position to the idling position in response to an actuating voltage received from the operating system, the actuating voltage is applied in response to the second signal being received from the brake switch, the idling valve coupling in fluid communication the fluid outlet of the pump to the hydraulic system when the idling valve is in the idling position.

24. A brake energy recovery system as claimed in claim 23 wherein the third criteria switch includes an engine speed sensor and switch designed to open when the speed of the engine is at least 900 RPM.

25. A brake energy recovery system comprising:
a vehicle including an engine, an auxiliary hydraulic system with a reservoir, a brake pedal, and an operating system;
a hydraulic pump mechanically coupled to the engine for rotation therewith and having a fluid inlet and a fluid outlet;
the reservoir coupled in fluid communication to the fluid inlet of the pump;
a high pressure hydraulic fluid accumulator;
a normally open switch coupled to the brake pedal so as to be closed when the brake pedal is depressed and a normally closed switch coupled to the brake pedal so as to be opened when the brake pedal is depressed;
a hydraulic charging valve coupled to the fluid outlet of the hydraulic pump and moveable between a charging position and a neutral position, the hydraulic charging valve coupling the fluid outlet of the hydraulic pump to the auxiliary hydraulic system in the neutral position, the charging valve including an actuator coupled to the operating system through the normally open switch for moving the charging valve from the neutral position to the charging position in response to an operating communication received from the operating system, the operating communication is received only when the normally open switch is in a closed position;
a motor valve coupled to the fluid inlet of the hydraulic pump and moveable between a driving position and a neutral position, the hydraulic motor valve coupling the fluid outlet of the hydraulic pump to the auxiliary hydraulic system in the neutral position, the hydraulic motor valve including an actuator coupled to the operating system through the normally closed switch for moving the motor valve from the neutral position to the driving position in response to an operating communication received from the operating system, the operating communication is received only when the normally closed switch is in a closed position;
the charging valve coupling in fluid communication the fluid outlet of the pump to the high pressure hydraulic fluid accumulator when the charging valve is in the charging position; and
the motor valve coupling in fluid communication the high pressure hydraulic fluid accumulator to the fluid inlet of the pump when the motor valve is in the driving position.

26. A brake energy recovery system as claimed in claim 25 wherein the operating system is one of an electrical system, an air system, and a hydraulic system and the normally open switch and the normally closed switch are one of electrical switches, air valves, and hydraulic valves.

27. A brake energy recovery system as claimed in claim 25 wherein at least the normally open switch is a brake light switch of the vehicle.

28. A brake energy recovery system as claimed in claim 27 further including a criteria switch connected in series with the normally open switch and the actuator of the hydraulic charging valve.

29. A brake energy recovery system as claimed in claim 28 wherein the criteria switch includes a normally open criteria switch connected to close when the vehicle reaches a predetermined speed.

30. A brake energy recovery system as claimed in claim 29 wherein the normally open criteria switch is connected to close when the vehicle reaches a speed of at least 3 miles per hour.

31. A brake energy recovery system as claimed in claim 28 wherein the criteria switch includes a normally closed criteria switch connected to open when pressure within high pressure hydraulic fluid accumulator reaches a predetermined value.

32. A brake energy recovery system as claimers in claim 31 wherein the normally closed criteria switch is connected to open when the pressure within high pressure hydraulic fluid accumulator reaches a value of at least 3000 PSI.

33. A brake energy recovery system as claimed in claim 26 further including a criteria switch connected in series with the normally closed switch and the actuator of the hydraulic motor valve.

34. A brake energy recovery system as claimed in claim 33 wherein the criteria switch includes a normally open criteria switch connected to close when pressure within high pressure hydraulic fluid accumulator reaches a predetermined value.

35. A brake energy recovery system as claimed in claim 34 wherein the normally open criteria switch is connected to close when the pressure within high pressure hydraulic fluid accumulator reaches a value of at least 300 PSI.

36. A brake energy recovery system as claimed in claim 26 further including a hydraulic idling valve couplable to the fluid outlet of the hydraulic pump and moveable between an idling position and a neutral position, the idling valve including an actuator coupled to a normally closed criteria switch and couplable to the operating system for moving the idling valve from the neutral position to the idling position in response to an operating communication received from the operating system, the operating communication is applied when the normally closed switch is in a closed position, the idling valve coupling in fluid communication the fluid outlet of the pump to the hydraulic system when the idling valve is in the idling position.

37. A brake energy recovery system as claimed in claim 36 wherein the normally closed criteria switch includes an engine speed sensor and switch designed to open when the speed of the engine is at least 900 RPM.

38. A brake energy recovery system comprising:
a vehicle including an engine, an auxiliary hydraulic system with a reservoir, a brake pedal, and an electrical system;
a hydraulic pump mechanically coupled to the engine for rotation therewith and having a fluid inlet and a fluid outlet;
the reservoir coupled in fluid communication to the fluid inlet of the pump;
a high pressure hydraulic fluid accumulator;
a normally open electrical switch coupled to the brake pedal so as to be closed when the brake pedal is depressed and a normally closed electrical switch coupled to the brake pedal so as to be opened when the brake pedal is depressed; a first criteria sensor including a first criteria switch operable between an open position and a closed position in response to a first criteria, the first criteria switch coupled in series with the normally open electrical switch to the electrical system;
a hydraulic charging valve coupled to the fluid outlet of the hydraulic pump and moveable between a charging position and a neutral position, the hydraulic charging valve coupling the fluid outlet of the hydraulic pump to the auxiliary hydraulic system in the neutral position, the charging valve including an actuator electrically coupled to the electrical system through the series connected normally open electrical switch and the first criteria switch for moving the charging valve from the neutral position to the charging position in response to an actuating voltage received from the electrical system, the actuating voltage is received only when the normally open electrical switch and the first criteria switch are in a closed position;
a second criteria sensor including a second criteria switch operable between an open position and a closed position in response to a second criteria, the second criteria switch coupled in series with the normally closed electrical switch to the electrical system;
a motor valve coupled to the fluid inlet of the hydraulic pump and moveable between a driving position and a neutral position, the hydraulic motor valve coupling the fluid outlet of the hydraulic pump to the auxiliary hydraulic system in the neutral position, the hydraulic motor valve including an actuator electrically coupled to the electrical system through the series connected normally closed electrical switch and the second criteria switch for moving the motor valve from the neutral position to the driving position in response to an actuating voltage received from the electrical system, the actuating voltage is received only when the normally closed electrical switch and the second criteria switch are in a closed position;
the charging valve coupling the fluid outlet of the pump to the high pressure hydraulic fluid accumulator in fluid communication when the charging valve is in the charging position; and
the motor valve coupling in fluid communication the high pressure hydraulic fluid accumulator to the fluid inlet of the pump when the motor valve is in the driving position.

39. A brake energy recovery system as claimed in claim 38 wherein at least the normally open electrical switch is a brake light switch of the vehicle.

40. A brake energy recovery system as claimed in claim 38 wherein the first criteria electrical switch includes a normally open criteria switch connected to close when the vehicle reaches a predetermined speed.

41. A brake energy recovery system as claimed in claim 40 wherein the normally open first criteria switch is connected to close when the vehicle reaches a speed of at least 3 miles per hour.

42. A brake energy recovery system as claimed in claim 38 wherein the first criteria electrical switch includes a normally closed first criteria switch connected to open when pressure within high pressure hydraulic fluid accumulator reaches a predetermined value.

43. A brake energy recovery system as claimed in claim 42 wherein the normally closed first criteria switch is connected to open when the pressure within high pressure hydraulic fluid accumulator reaches a value of at least 3000 PSI.

44. A brake energy recovery system as claimed in claim 38 wherein the second criteria electrical switch includes a normally open second criteria switch connected to close when pressure within high pressure hydraulic fluid accumulator reaches a predetermined value.

45. A brake energy recovery system as claimed in claim 44 wherein the normally open second criteria switch is connected to close when the pressure within high pressure hydraulic fluid accumulator reaches a value of at least 300 PSI.

46. A brake energy recovery system as claimed in claim 38 further including a hydraulic idling valve couplable to the fluid outlet of the hydraulic pump and moveable between an idling position and a neutral position, the idling valve including an actuator electrically coupled to a normally closed electrical criteria switch and couplable to the electrical system for moving the idling valve from the neutral position to the idling position in response to an actuating voltage received from the electrical system, the actuating voltage is applied when the normally closed electrical switch is in a closed position, the idling valve coupling in fluid communication the fluid outlet of the pump to the hydraulic system when the idling valve is in the idling position.

47. A brake energy recovery system as claimed in claim 46 wherein the normally closed criteria switch includes an engine speed sensor and switch designed to open when the speed of the engine is at least 900 RPM.

48. A method of installing a brake energy recovery system in a vehicle comprising the steps of:
providing a vehicle including an engine, an auxiliary hydraulic system with a reservoir and a hydraulic pump, a brake pedal, an operating system, the hydraulic pump being mechanically coupled to the engine for rotation therewith and having a fluid inlet and a fluid outlet, and the reservoir coupled in fluid communication to the fluid inlet of the pump;
providing a normally open switch coupled to the brake pedal so as to be closed when the brake pedal is depressed and a normally closed switch coupled to the brake pedal so as to be opened when the brake pedal is depressed;
coupling an actuator of a hydraulic charging valve moveable between a charging position and a neutral position to the operating system through the open switch for moving the hydraulic charging valve from the neutral position to the charging position in response to an operating communication received from the operating system;
hydraulically coupling the fluid outlet of the hydraulic pump through the hydraulic charging valve in the neutral position to the auxiliary hydraulic system;
hydraulically coupling the fluid outlet of the hydraulic pump through the hydraulic charging valve in the charging position to a high pressure hydraulic fluid accumulator;
coupling an actuator of a hydraulic motor valve moveable between a driving position and a neutral position to the operating system through the normally closed switch for moving the hydraulic motor valve from the neutral position to the driving position in response to an operating communication received from the operating system;
hydraulically coupling the fluid inlet of the hydraulic pump through the hydraulic motor valve in the neutral position to the auxiliary hydraulic system; and
hydraulically coupling the high pressure hydraulic fluid accumulator through the hydraulic motor valve in the motor position to the fluid inlet of the hydraulic pump.

49. A method as claimed in claim 48 wherein the step of providing a vehicle includes providing a vehicle with a brake light switch that closes when the brake pedal is depressed and including the step of using the brake light switch as the normally open switch.

50. A method as claimed in claim 48 further including a step of connecting a criteria switch in series with the normally open switch and the actuator of the hydraulic charging valve.

51. A method as claimed in claim 50 wherein the step of connecting the criteria switch includes connecting a normally open criteria switch to close when the vehicle reaches a predetermined speed.

52. A method as claimed in claim 51 wherein the step of connecting the normally open criteria switch includes connecting the normally open criteria switch to close when the vehicle reaches a speed of at least 3 miles per hour.

53. A method as claimed in claim 50 wherein the step of connecting the criteria switch includes connecting a normally closed criteria switch to open when pressure within high pressure hydraulic fluid accumulator reaches a predetermined value.

54. A method as claimed in claim 53 wherein the step of connecting the normally closed criteria switch includes connecting the normally closed criteria switch to open when the pressure within high pressure hydraulic fluid accumulator reaches a value of at least 3000 PSI.

55. A method as claimed in claim 48 further including a step of connecting a criteria switch in series with the normally closed switch and the actuator of the hydraulic motor valve.

56. A method as claimed in claim 55 wherein the step of connecting the criteria switch includes connecting a normally open criteria switch to close when pressure within high pressure hydraulic fluid accumulator reaches a predetermined value.

57. A method as claimed in claim 56 wherein the step of connecting the normally open criteria switch includes connecting the normally open criteria switch to close when the pressure within high pressure hydraulic fluid accumulator reaches a value of at least 300 PSI.

58. A method as claimed in claim 57 wherein the step of hydraulically coupling a hydraulic idling valve moveable between an idling position and a neutral position to the fluid outlet of the hydraulic pump, coupling an actuator of the idling valve to a normally closed criteria switch and to the operating system for moving the idling valve from the neutral position to the idling position in response to an operating communication received from the operating system, connecting the actuator of the idling valve and the normally closed criteria switch to apply the operating communication when the normally closed criteria switch is in a closed position, and hydraulically coupling the fluid outlet of the pump through the idling valve to the hydraulic system when the idling valve is in the idling position.

59. A method as claimed in claim 57 wherein the step of coupling an actuator of the idling valve to a normally closed criteria switch includes coupling an engine speed sensor and switch designed to open when the speed of the engine is at least 900 RPM to the actuator.

60. A method as claimed in claim 48 wherein the step of providing a vehicle including an operating system includes providing one of an electrical system, an air system, and a hydraulic system and the step of providing the normally open switch and the normally closed switch includes providing one of electrical switches, air valves, and hydraulic valves.

61. A method of installing a brake energy recovery system in a vehicle comprising the steps of:
providing a vehicle including an engine, an auxiliary hydraulic system with a reservoir and a hydraulic pump, a brake pedal, an operating system, the hydraulic pump being mechanically coupled to the engine for rotation therewith and having a fluid inlet and a fluid outlet, and the reservoir coupled in fluid communication to the fluid inlet of the pump;
providing control valves and a high pressure accumulator to supplement the auxiliary hydraulic system of the vehicle;
coupling the control valves to the brake pedal and arranging the control valves to activate a first signal when the brake pedal is depressed and to activate a second signal when the brake pedal is released;
providing a criteria switch that operates in response to the meeting of a criteria and coupling the criteria switch to the control valves to transmit the first signal only when the criteria is met; and
coupling the control valves, the hydraulic system of the vehicle, and the high pressure accumulator to transmit hydraulic pressure to the high pressure accumulator from the fluid outlet of the pump when the first signal is activated and until the criteria switch terminates the first signal and to transmit hydraulic pressure from the high pressure accumulator to the fluid inlet of the pump when the second signal is activated.
